(19) United States
(12) Patent Application Publication
(10) Pub. No.: US 2026/0109219 A1
(43) Pub. Date: Apr. 23, 2026

(54) CONTROL DEVICE

(71) Applicant: SUBARU CORPORATION, Tokyo (JP)

(72) Inventors: Yukinobu KATAYAMA, Tokyo (JP); Takahiro YONEYAMA, Tokyo (JP); Masaaki TAKAHASHI, Tokyo (JP); Keita KOIKE, Tokyo (JP)

(21) Appl. No.: 19/357,210

(22) Filed: Oct. 14, 2025

(30) Foreign Application Priority Data
Oct. 22, 2024 (JP) 2024-186176

(51) Int. Cl. B60K 35/10; B60K 35/22; B60K 35/65

(52) U.S. Cl. CPC B60K 35/10; B60K 35/22; B60K 35/654; B60K 2360/143

(57) ABSTRACT

A control device is configured to control a vehicle-mounted device that is mounted in a vehicle. The control device includes one or more processors and one or more memories. The one or more memories are coupled to the one or more processors such that the one or more memories are capable of communicating with the one or more processors. The one or more processors are configured to determine whether an external load is applied to a movable member or an operation member of the vehicle-mounted device, and output, to a driver who drives the vehicle, a setting screen for changing a setting of the vehicle-mounted device to which the external load is applied when it is determined that the external load is applied.

### CROSS-REFERENCE TO RELATED APPLICATIONS

The present application claims priority from Japanese Patent Application No. 2024-186176 filed on Oct. 22, 2024, the entire contents of which are hereby incorporated by reference.

### BACKGROUND

The present disclosure relates to a control device.

In recent years, reductions in vehicle components and the simple design thereof have been achieved because of the transfer of the function of a physical switch that is physically operated by a driver who drives a vehicle to an input-output device such as a touchscreen.

For example, a vehicle-mounted system disclosed in Japanese Unexamined Patent Application Publication (JP-A) No. 2014-151709 includes an attachment that is provided in a vehicle cabin and a selection unit that includes multiple replaceable elements that are selectively attachable to the attachment and that are capable of fulfilling respective different vehicle functions, the vehicle-mounted system is used with any one replaceable element that is selected from the replaceable elements being attached to the attachment, and a display displays information associated with the kind of the replaceable element that is attached to the attachment.

A vehicle information displaying apparatus disclosed in JP-A No. 2008-137558 includes a vehicle state monitor that monitors the state of a component that is included in a vehicle, a malfunction state determinator that determines whether the state of the component that is acquired by the vehicle state monitor is abnormal, a vehicle information storage that stores abnormal state countermeasure information that includes a countermeasure for a malfunction of the component that is included in the vehicle, and a display unit that has a warning display function of causing a display to display an abnormal state warning screen for warning the occurrence of the malfunction of the component when the malfunction state determinator determines that the state of the component is abnormal and a countermeasure display function of extracting the abnormal state countermeasure information associated with the malfunction of the component from the vehicle information storage and causing the display to display the countermeasure in response to an instruction for displaying the countermeasure for the malfunction of the component while the abnormal state warning screen is displayed.

### SUMMARY

An aspect of the disclosure provides a control device configured to control a vehicle-mounted device that is mounted in a vehicle. The control device includes one or more processors and one or more memories. The one or more memories are coupled to the one or more processors such that the one or more memories are capable of communicating with the one or more processors. The one or more processors are configured to determine whether an external load is applied to a movable member or an operation member of the vehicle-mounted device, and output, to a driver who drives the vehicle, a setting screen for changing a setting of the vehicle-mounted device to which the external load is applied when it is determined that the external load is applied.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic diagram illustrating an example of the structure of a vehicle according to an embodiment of the present disclosure;

FIG. 2 schematically illustrates the vicinity of a driver's seat of a vehicle according to the embodiment of the present disclosure;

FIG. 3 is a block diagram illustrating the example of the structure of a control device according to an embodiment of the present disclosure;

FIG. 4 schematically illustrates an example of a setting screen according to the embodiment of the present disclosure;

FIG. 5 schematically illustrates another example of the setting screen according to the embodiment of the present disclosure; and

FIG. 6 is a flowchart for describing an example of the operation of the control device according to the embodiment of the present disclosure.

### DETAILED DESCRIPTION

According to JP-A No. 2014-151709, a new replaceable element is attached, and subsequently, a setting screen regarding the new replaceable element is displayed. According to JP-A No. 2008-137558, when the malfunction of the component that is included in the vehicle occurs, the countermeasure for the malfunction is displayed on the warning screen. However, neither JP-A No. 2014-151709 nor JP-A No. 2008-137558 discloses that a setting screen of a vehicle-mounted device is displayed depending on the driver's intention to change the setting of the vehicle-mounted device.

Some existing techniques involve multiple screen operations for displaying the setting screen of the vehicle-mounted device that is desired by the driver. In some cases, the driver identifies a position on the displayed screen to be operated by reading, for example, a text or an image. For this reason, there is a risk that the driver looks ahead carelessly when changing the setting of the vehicle-mounted device.

The present disclosure has been accomplished in view of these circumstances, and it is desirable to provide a technique for inhibiting the driver from looking ahead carelessly when the driver changes the setting of the vehicle-mounted device.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### 1. Vehicle

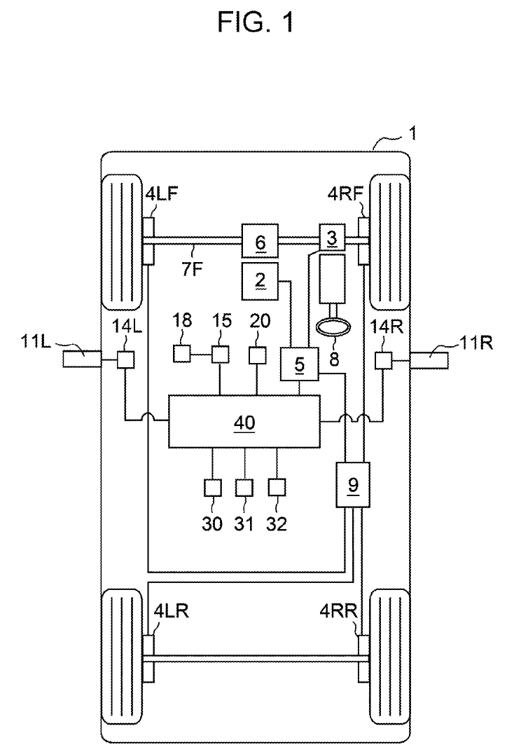

Referring to FIG. 1, a vehicle 1 is configured as a four-wheel automobile in which drive torque that is outputted from a drive power source 2 is transmitted to wheels. A combination of driving wheels and a driving method are not limited. The vehicle 1 may be a front-wheel drive vehicle, may be a rear-wheel drive vehicle, or may be a four-wheel drive vehicle. The vehicle 1 may be an automobile that includes an internal combustion engine such as a gasoline engine or a diesel engine that serves as the drive power source 2 or may be an electric automobile that includes a drive motor that serves as the drive power source 2. Examples of the electric automobile include a battery electric vehicle (BEV), a hybrid electric vehicle (HEV), a plug-in hybrid electric vehicle (PHEV), and a fuel cell electric vehicle (FCEV).

The vehicle 1 includes devices that are used for driving control such as an electric steering device 3, brake devices 4LF, 4RF, 4LR, and 4RR (referred to below as "brake devices 4"), and a vehicle control device 5 in addition to the drive power source 2 described above.

The drive power source 2 outputs the drive torque that is transmitted to a front-wheel drive shaft 7F via a transmission (not illustrated) and a differential mechanism 6. The vehicle control device 5 controls the drive of the drive power source 2.

The electric steering device 3 is provided on the front-wheel drive shaft 7F. The electric steering device 3 includes an electric motor (not illustrated) and a gear mechanism (not illustrated). The steering angles of the front wheels are adjusted under the control of the vehicle control device 5. The vehicle control device 5 controls the electric steering device 3, based on the steering angle of a steering wheel 8 that is manipulated by a driver who drives the vehicle. When the vehicle 1 is capable of implementing autonomous driving control, the vehicle control device 5 controls the electric steering device 3, based on the steering angle of the steering wheel 8 that is manipulated by the driver during manual driving. During autonomous driving, the vehicle control device 5 controls the electric steering device 3, based on a steering angle or a steering angular velocity that is appropriately set by using a known autonomous driving technology or any autonomous driving technology.

The brake devices 4 apply braking force to the wheels. Examples of the brake devices 4 may include hydraulic brake devices. In this case, the drive of a hydraulic unit 9 is controlled by the vehicle control device 5, and consequently, hydraulic pressure that is applied to the brake devices 4 is adjusted. When the vehicle 1 is configured as an electric automobile, the brake devices 4 are used together with regenerative braking with a drive motor.

The vehicle control device 5 includes at least one or more electronic control units (one or more ECUs) that control the drive of the drive power source 2, the electric steering device 3, and the brake devices 4. The vehicle control device 5 may be divided for every function.

The vehicle 1 further includes vehicle-mounted devices such as door mirrors 11L and 11R and an air conditioner 15, an input-output device 20, and a control device 40 in addition to the drive power source 2, the electric steering device 3, the brake devices 4, and the vehicle control device 5 described above.

The vehicle-mounted devices described herein are any devices that are mounted in the vehicle 1 and that enable the driver to change their settings and are not necessarily limited to the door mirrors 11L and 11R or the air conditioner 15.

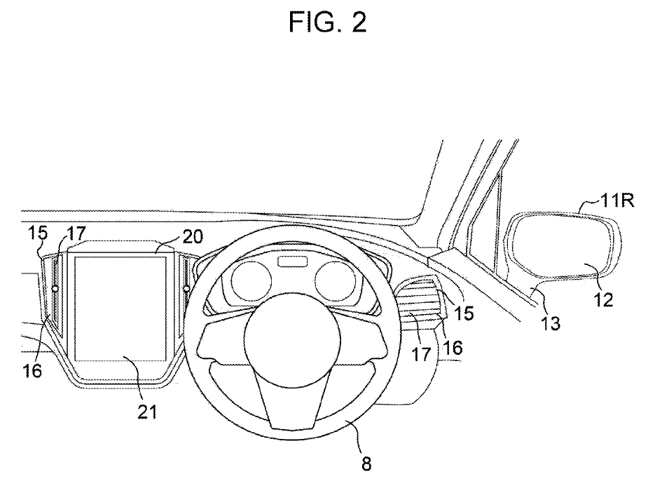

Also referring to FIG. 2, for example, when the door mirrors 11L and 11R are intended as vehicle-mounted devices, movable members of the vehicle-mounted devices are mirror surfaces 12 or stowage mechanisms 13 of the door mirrors 11L and 11R. The door mirrors 11L and 11R are electric mirrors that include actuators (not illustrated) that are capable of tilting the mirror surfaces 12 in left-hand, right-hand, upward, and downward directions and that are capable of opening and closing the door mirrors 11L and 11R by driving the stowage mechanisms 13. Also referring to FIG. 1, the door mirrors 11L and 11R include mirror sensors 14L and 14R that are capable of detecting an external load that is applied to the mirror surfaces 12 or the stowage mechanisms 13. Examples of the mirror sensors 14L and 14R include a known contact sensor, any contact sensor, a load sensor, or a displacement sensor. When the mirror sensors 14L and 14R detect the external load that is applied to the mirror surfaces 12 or the stowage mechanisms 13, the mirror sensors 14L and 14R transmit, to the control device 40, the result of detection of the external load.

Also referring to FIG. 2, for example, when the air conditioner 15 is intended as a vehicle-mounted device, movable members of the vehicle-mounted device are multiple flaps 17 that are provided at an outlet 16 of the air conditioner 15 and that are capable of adjusting the amount and direction of air from the outlet 16. The flaps 17 may be rotatable about a predetermined axis due to driving force that is outputted from a motor (not illustrated) that is coupled to the vehicle control device 5. Also referring to FIG. 1, an air conditioning sensor 18 that is capable of detecting an external load that is applied to each flap 17 is provided at the outlet 16 of the air conditioner 15. Examples of the air conditioning sensor 18 include a contact sensor, a load sensor, or a displacement sensor. When the air conditioning sensor 18 detects the external load that is applied to one or more flaps 17 among the multiple flaps 17, the air conditioning sensor 18 transmits, to the control device 40, the result of detection of the external load.

The input-output device 20 is provided on, for example, an instrument panel of the vehicle 1. Also referring to FIG. 2, the input-output device 20 includes a display 21 of a touchscreen type that is capable of outputting various kinds of information to the driver of the vehicle 1, for example, by displaying an image or a text and that is capable of receiving the input operation of the driver. The operation of the control device 40 causes the display 21 of the input-output device 20 to display a setting screen for changing the settings of the vehicle-mounted devices although the detail will be described later. The input-output device 20 may be integrated with a navigation system.

According to an embodiment of the disclosure, the control device 40 serves as a device for controlling the vehicle-mounted devices that are mounted in the vehicle 1 although the detail will be described later.

The vehicle 1 may further include a surrounding environment sensor 30, a vehicle state sensor 31, and a position detection sensor 32.

The surrounding environment sensor 30 may include a front camera (not illustrated) and a rear camera (not illustrated). The front camera photographs a location in front of the vehicle 1 and generates image data. The rear camera photographs a location behind the vehicle 1 and generates image data. The front camera and the rear camera include imaging elements such as charged coupled devices (CCD) or complementary metal oxide semiconductor (CMOS) and transmit the generated image data to the control device 40. The surrounding environment sensor 30 may include a radar sensor such as a light detection and ranging (LiDAR) sensor or a millimeter-wave radar sensor, an ultrasonic sensor, or multiple distance sensors (not illustrated).

The vehicle state sensor 31 includes one or more sensors that detect the behavior and operational state of the vehicle 1. For example, the vehicle state sensor 31 may include a steering angle sensor, an accelerator position sensor, a brake stroke sensor, a brake pressure sensor, or an engine revolution sensor. For example, the vehicle state sensor 31 may include a vehicle speed sensor, an acceleration sensor, or an angular speed sensor. The vehicle state sensor 31 transmits the result of detection of these to the control device 40.

The position detection sensor 32 may include a global navigation satellite system (GNSS) sensor. The GNSS sensor receives a satellite signal from a positioning satellite such as a global positioning system (GPS) satellite. The GNSS sensor transmits information about the position of the vehicle 1 that is included in the received satellite signal to the control device 40. The vehicle 1 may also include an antenna that receives a satellite signal from another satellite system that identifies the position of the vehicle 1 in addition to the position detection sensor 32.

### 2. Control Device

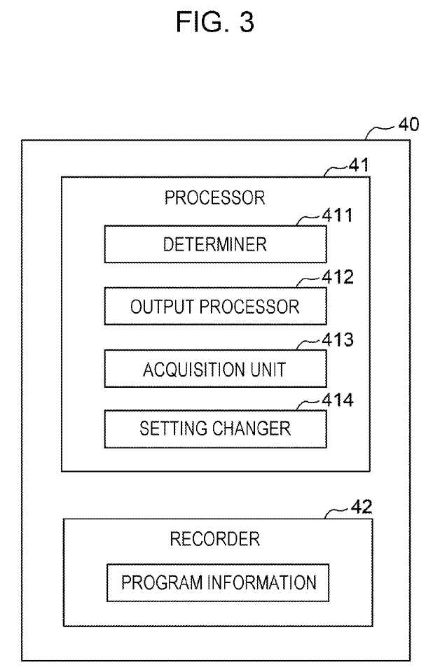

The control device 40 according to the present embodiment will be described in detail with reference to FIG. 3.

### 2-1. Example of Structure of Control Device

According to an embodiment of the disclosure, the control device 40 serves as a device for controlling the vehicle-mounted devices that are mounted in the vehicle 1 in a manner in which one or more processors such as one or more central processing units (one or more CPUs) run a computer program. The computer program causes the one or more processors to perform an operation to be performed by the control device 40 described later. The computer program that is run by the one or more processors may be recorded in a recording medium that serves as a recorder (a memory) 42 described later according to an embodiment of the disclosure, or may be recorded in a recording medium that is contained in the control device 40 or any recording medium that can be externally coupled to the control device 40.

Examples of the recording medium that records the computer program may include magnetic media such as a hard disk, a floppy disk, and a magnetic tape, optical recording media such as a CD-ROM, a DVD, or a Blu-ray (registered trademark), a magneto-optical medium such as a floptical disk, storage elements such as a RAM and a ROM, flash memories such as a USB memory and an SSD, and other media that are capable of storing the program.

The control device 40 includes at least a processor 41 and the recorder 42.

The processor 41 includes one or more processors such as one or more CPUs and various peripheral components. A part or the whole of the processor 41 may be configured as an updatable component such as firmware or may be a program module that is run in response to an instruction from, for example, the one or more CPUs.

The recorder 42 includes one or more storage elements such as one or more RAMs or one or more ROMs that are coupled to the processor 41 such that the one or more storage elements are capable of communicating with the processor 41. However, the kind and number of the recorder 42 are not limited. The recorder 42 stores a computer program that is run by the processor 41 and information such as various parameters that are used in an arithmetic operation, the detection data, and the result of the arithmetic operation.

Identification information for identifying the vehicle-mounted devices and program information for outputting the setting screen for changing the settings of the vehicle-mounted devices to the input-output device 20 are associated with each other in advance and stored in the recorder 42.

The control device 40 is coupled to the vehicle control device 5, the vehicle-mounted devices such as the door mirrors 11L and 11R and the air conditioner 15, the input-output device 20, the surrounding environment sensor 30, the vehicle state sensor 31, and the position detection sensor 32 with a communication unit such as a dedicated line, a controller area network (CAN), or a local interconnect network (LIN) interposed therebetween. The vehicle control device 5 may have a part or the whole of the function of the control device 40.

### 2-2. Functional Configuration of Processor

The functional configuration of the processor 41 of the control device 40 will be described. The processor 41 includes a determiner 411, an output processor 412, an acquisition unit 413, and a setting changer 414. These components correspond to functions that are fulfilled by running a computer program by one or more processors such as one or more CPUs. However, some or all of these components may be configured by using an analog circuit.

### Determiner

The determiner 411 determines whether an external load is applied to a movable member of a vehicle-mounted device. For example, the determiner 411 acquires the magnitude of the external load that is included in the result of detection performed by a sensor that is provided on the vehicle-mounted device. The determiner 411 determines that the external load is applied to the movable member of the vehicle-mounted device when the acquired magnitude of the external load is within a predetermined range for detecting contact of the driver of the vehicle 1 with the movable member of the vehicle-mounted device.

The lower limit of the predetermined range can be appropriately determined in consideration of the sensitivity of the sensor such that the sensor that is provided on the vehicle-mounted device is capable of detecting artificial contact. The upper limit of the predetermined range can be appropriately determined depending on the kind of the vehicle-mounted device such that the position of the movable member of the vehicle-mounted device is not changed, or the vehicle-mounted device does not malfunction even when the position thereof is changed due to the external load. The upper limit of the predetermined range can be omitted.

For example, when the door mirrors 11L and 11R are intended as vehicle-mounted devices, and when the magnitude of the external load that is included in the result of determination performed by the mirror sensor 14L or 14R is within a predetermined range, the determiner 411 determines that the external load caused by the contact of the driver with the mirror surface 12 or the stowage mechanism 13 of the door mirror 11L or 11R is applied. For example, when the air conditioner 15 is intended as a vehicle-mounted device, and when the magnitude of the external load that is included in the result of detection performed by the air conditioning sensor 18 is within a predetermined range, the determiner 411 determines that the external load caused by the contact of the driver with the one or more flaps 17 is applied.

### Output Processor

When the determiner 411 determines that the external load is applied, the output processor 412 outputs, to the driver, the setting screen for changing the setting of the vehicle-mounted device to which the external load is applied. For example, the output processor 412 refers to the recorder 42, identifies the identification information about the vehicle-mounted device to which the external load is applied, and identifies the program information for outputting the setting screen of the vehicle-mounted device that is associated with the identified identification information. The output processor 412 reads the identified program information, generates an output signal for outputting the setting screen of the vehicle-mounted device to which the external load is applied, and transmits the output signal to the input-output device 20. Consequently, the display 21 of the input-output device 20 displays the setting screen of the vehicle-mounted device to which the external load is applied. Setting items that are included in the setting screen may be setting items for the movable member of the vehicle-mounted device or may be all setting items that are changeable by the driver.

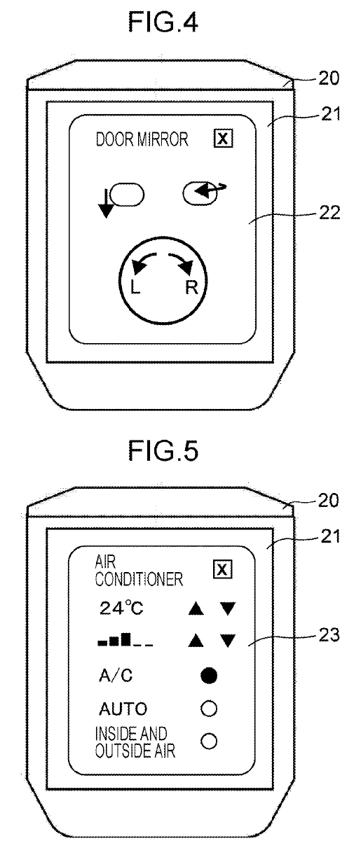

For example, when the door mirrors 11L and 11R are intended as vehicle-mounted devices, and when the determiner 411 determines that the external load is applied to the mirror surface 12 or the stowage mechanism 13 of the door mirror 11L or 11R, the output processor 412 performs processing described below. That is, the output processor 412 causes the display 21 of the input-output device 20 to display a setting screen 22 for changing the settings of the open/close state of the door mirror 11L or 11R and the tilt angle of the mirror surface 12 illustrated in FIG. 4. For example, when the air conditioner 15 is intended as a vehicle-mounted device, and when the determiner 411 determines that the external load is applied to the one or more flaps 17 that are provided at the outlet 16 of the air conditioner 15, the output processor 412 performs processing described below. That is, the output processor 412 causes the display 21 of the input-output device 20 to display a setting screen 23 for changing the setting of the air conditioner 15 illustrated in FIG. 5.

The input-output device 20 may be capable of displaying multiple screens that are structured in advance into multiple layers sequentially from an upper layer toward a lower layer in response to the input operation of the driver. That is, the input-output device 20 may typically receive multiple screen operations from the driver until the layer of the screen that is desired by the driver is reached. In this case, when the determiner 411 determines that the external load is applied, the output processor 412 may perform processing described below unlike a normal case. That is, the output processor 412 may temporarily set, as an uppermost layer, the layer of the setting screen for the vehicle-mounted device to which the external load is applied and may cause the input-output device 20 to display the setting screen without the input operation of the driver. The output processor 412 may restore the temporarily set layer to the original layer after the setting screen is displayed. For example, the program information for outputting the setting screen of the vehicle-mounted device that is stored in the recorder 42 to the input-output device 20 also includes path information for outputting, into the uppermost layer of the input-output device 20, the setting screen of the vehicle-mounted device to which the external load is applied. The output processor 412 identifies the identification information about the vehicle-mounted device to which the external load is applied and identifies the path information for outputting, into the uppermost layer of the input-output device 20, the setting screen of the vehicle-mounted device that is associated with the identified identification information. The output processor 412 reads the identified path information, generates an output signal for outputting, into the uppermost layer of the input-output device 20, the setting screen of the vehicle-mounted device to which the external load is applied, and transmits the output signal to the input-output device 20. Consequently, the driver may not perform multiple screen operations until the layer of the setting screen of the vehicle-mounted device that is desired is reached and can cause the setting screen to be directly displayed merely by touching the vehicle-mounted device. The "uppermost layer" means that the screen that is displayed on the display 21 of the input-output device 20 is disposed at the topmost position in the display 21.

The output processor 412 may cause the setting screen of the vehicle-mounted device to which the external load is applied to be displayed more preferentially or emphatically than another screen that is displayed on the input-output device 20 when the setting screen is displayed on the input-output device 20. For example, when another screen such as a navigation screen for navigating the vehicle 1 is displayed on the input-output device 20, the output processor 412 may cause the setting screen of the vehicle-mounted device to be preferentially displayed by replacing the other screen such as the navigation screen. When the other screen such as the navigation screen is displayed on the input-output device 20, the output processor 412 may cause the setting screen of the vehicle-mounted device to be emphatically displayed, for example, as a popup screen. However, when the travel state of the vehicle 1 that is identified by the surrounding environment sensor 30, the vehicle state sensor 31, or the position detection sensor 32 of the vehicle 1 is a state in which the driver is to look ahead carefully, the output processor 412 may perform processing described below. That is, after the vehicle 1 ends the current travel state, the output processor 412 may cause the input-output device 20 to display the setting screen of the vehicle-mounted device. Examples of the state in which the driver is to look ahead carefully include a state in which a certain number or more of obstacles such as other vehicles or pedestrians are near the vehicle 1, a state in which the speed of the vehicle 1 is equal to or more than a reference value, and a state in which the vehicle 1 enters an intersection and so on, but the present disclosure is not limited thereto.

### Acquisition Unit

The acquisition unit 413 acquires the target setting value of the vehicle-mounted device to which the external load is applied, based on the input operation of the driver into the setting screen that is outputted on the input-output device 20.

For example, when the door mirrors 11L and 11R are intended as vehicle-mounted devices, the acquisition unit 413 performs processing described below. That is, the acquisition unit 413 acquires a target setting value depending on the pressing operation of the driver against a virtual switch for setting the tilt angle of the mirror surface 12 or the open/close state of the door mirror 11L or 11R that is included in the setting screen 22 that is displayed on the display 21 of the input-output device 20 illustrated in FIG. 4. For example, when the air conditioner 15 is intended as a vehicle-mounted device, the acquisition unit 413 performs processing described below. That is, the acquisition unit 413 acquires a target setting value depending on the pressing operation of the driver against a virtual switch for setting the temperature, the amount of air, the mode, or the like of the air conditioner 15 that is included in the setting screen 23 that is displayed on the display 21 of the input-output device 20 illustrated in FIG. 5.

### Setting Changer

The setting changer 414 changes the setting of the vehicle-mounted device, based on the target setting value that is acquired by the acquisition unit 413. For example, the setting changer 414 generates a control signal for changing the setting value of the vehicle-mounted device into the target setting value that is acquired by the acquisition unit 413 and transmits the control signal to the vehicle-mounted device. Consequently, the vehicle-mounted device is movable up to the target setting value that is set by the driver or acts depending on the target setting value.

For example, when the door mirrors 11L and 11R are intended as vehicle-mounted devices, the mirror surface 12 or the stowage mechanism 13 of the door mirror 11L or 11R is movable from a position when the driver applies the external load to a position specified by the target setting value. For example, when the air conditioner 15 is intended as a vehicle-mounted device, the air conditioner 15 changes the setting value when the driver applies the external load into the target setting value and acts depending on the target setting value.

### 2-3. Example of Operation of Control Device

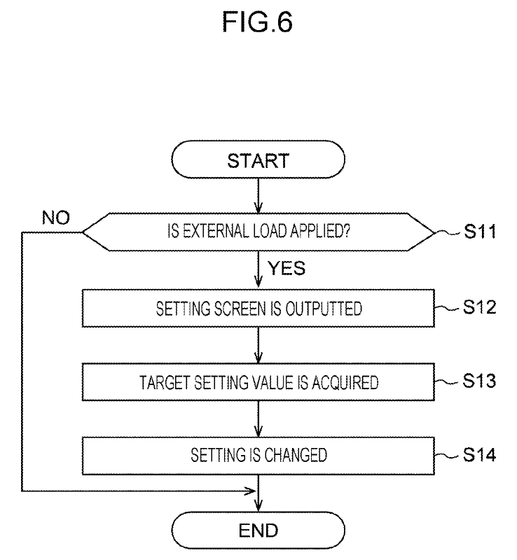

An example of the operation of the control device 40 according to the present embodiment will be described with reference to a flowchart in FIG. 6.

The example of the operation starts when the driver touches the flaps 17 that are provided at the outlet 16 of the air conditioner 15 that correspond to movable members of a vehicle-mounted device while the vehicle 1 travels. However, the present disclosure is not limited to the example of the operation but can be used for any vehicle-mounted device.

At step S11, the determiner 411 of the processor 41 determines whether the external load is applied to the movable members of the vehicle-mounted device. In the example of the operation, the determiner 411 determines whether the magnitude of the external load that is included in the result of detection performed by the air conditioning sensor 18 that is provided at the outlet 16 of the air conditioner 15 is within a predetermined range for detecting contact of the driver with the flaps 17. When the magnitude of the external load is within the predetermined range, the determiner 411 determines that the external load is applied to the flaps 17 due to the contact of the driver. When it is determined that the external load is applied (YES at step S11), a process at step S12 is performed. When it is not determined that the external load is applied (NO at step S11), the processing ends.

At step S12, the output processor 412 of the processor 41 outputs, to the driver, the setting screen for changing the setting of the vehicle-mounted device to which it is determined at step S11 that the external load is applied. In the example of the operation, the output processor 412 temporarily sets, as the uppermost layer, the layer of the setting screen 23 for changing the setting of the air conditioner 15 to which it is determined that the external load is applied as illustrated in FIG. 5 and causes the display 21 of the input-output device 20 to display the layer without the input operation of the driver. Consequently, the driver may not perform multiple screen operations and can be inhibited from looking ahead carelessly when the setting screen of the air conditioner 15 is displayed. Subsequently, a process at step S13 is performed.

When another screen such as the navigation screen is displayed on the display 21 of the input-output device 20, the output processor 412 may replace the other screen such as the navigation screen and may cause the display 21 of the input-output device 20 to preferentially display the setting screen 23 of the air conditioner 15 instead of step S12. When the other screen such as the navigation screen is displayed on the display 21 of the input-output device 20 at step S12, the output processor 412 may cause the display 21 of the input-output device 20 to emphatically display the setting screen 23 of the air conditioner 15, for example, as a popup screen.

At step S13, the acquisition unit 413 of the processor 41 acquires the target setting value of the vehicle-mounted device to which the external load is applied, based on the input operation of the driver into the setting screen that is outputted at step S12. In the example of the operation, the acquisition unit 413 acquires the target setting value of the air conditioner 15, based on the pressing operation of the driver against a virtual switch that is included in the setting screen 23 of the air conditioner 15 that is displayed on the display 21 of the input-output device 20. Subsequently, a process at step S14 is performed.

At step S14, the setting changer 414 of the processor 41 changes the setting of the vehicle-mounted device, based on the target setting value that is acquired at step S13. In the example of the operation, the setting changer 414 changes the setting of the air conditioner 15 into the target setting value that is acquired at step S13. Consequently, the air conditioner 15 acts depending on the target setting value. Subsequently, the processing ends.

### 3. Summary

The control device 40 according to the present embodiment controls the vehicle-mounted devices that are mounted in the vehicle 1 as described above. The processor 41 of the control device 40 determines whether the external load is applied to a movable member of a vehicle-mounted device. When it is determined that the external load is applied, the processor 41 outputs the setting screen for changing the setting of the vehicle-mounted device to which the external load is applied.

With this structure, when a hand of the driver of the vehicle 1, for example, touches the vehicle-mounted device for which the setting is to be changed, the control device 40 recognizes the driver's intention to operate the vehicle-mounted device, and the setting screen of the vehicle-mounted device can be displayed. For this reason, the driver may not perform multiple screen operations, may not read, for example, a text or an image, and may not make, for example, a specific gesture when the setting screen of the vehicle-mounted device is displayed, and the intuitive operability of the driver is improved. Accordingly, the driver can be inhibited from looking ahead carelessly when the setting of the vehicle-mounted device is changed.

The embodiment of the present disclosure is described in detail above with reference to the attached drawings, but the present disclosure is not limited to the embodiment. It is clear for a person skilled in the art to which the present disclosure belongs to conceive various modifications and alterations within the range of technical ideas recited in claims, and these are naturally included in the technical range of the present disclosure. For example, functions that are included in the components or the steps, for example, can be rearranged without logical contradiction, and multiple components or steps, for example, can be combined or split.

### First Modification

According to a first modification, the processor 41 of the control device 40 determines whether the external load is applied to an operation member of a vehicle-mounted device instead of a movable member of a vehicle-mounted device and outputs the setting screen for changing the setting of the vehicle-mounted device to which the external load is applied when it is determined that the external load is applied. When the magnitude of the external load is within a predetermined range for detecting an operation on the operation member of the vehicle-mounted device, the processor 41 may determine that the external load is applied. The following description contains differences from the embodiment described above when a headlight, a wiper, or a power window, for example, is used as a vehicle-mounted device, and as for other matters, the above description of the embodiment is incorporated herein by reference.

For example, when the headlight is intended as a vehicle-mounted device, the operation member of the vehicle-mounted device is a light switch that is provided on a light lever mounted on a steering column and that is used to change the operation mode of the headlight. The operation mode of the headlight may include an on-mode in which the headlight is turned on, an off-mode in which the headlight is turned off, and an automatic mode in which the headlight is automatically turned on or turned off depending on ambient brightness around the vehicle 1. The light lever is configured to be capable of transmitting, to the control device 40, the result of detection of the external load when the external load to the light switch is detected during the automatic mode. The processor 41 of the control device 40 outputs, to the driver, a setting screen for changing the setting of the headlight that corresponds to the vehicle-mounted device to which it is determined that the external load is applied as in the embodiment described above. The setting screen that is displayed on the display 21 of the input-output device 20 may include a virtual switch that can be operated by the driver and that is used to set, for example, the sensitivity of the headlight to the ambient brightness around the vehicle 1. This enables the driver to be inhibited from looking ahead carelessly when the setting of the headlight is changed and enables the driver to be inhibited from being unpleasant to the current setting value in the automatic mode.

For example, when the wiper is intended as a vehicle-mounted device, the operation member of the vehicle-mounted device is a wiper switch that is provided on a wiper lever mounted on the steering column and that is used to change the operation mode of the wiper. The operation mode of the wiper may include a mist mode, an off-mode, an automatic mode, a low-speed mode, an intermediate-speed mode, and a high-speed mode. The wiper lever is configured to be capable of transmitting, to the control device 40, the result of detection of the external load when the external load to the wiper switch is detected during the automatic mode. The processor 41 of the control device 40 outputs, to the driver, a setting screen for changing the setting of the wiper that corresponds to the vehicle-mounted device to which it is determined that the external load is applied as in the embodiment described above. The setting screen that is displayed on the display 21 of the input-output device 20 may include a virtual switch that can be operated by the driver and that is used to set, for example, an interval amount in the automatic mode. This enables the driver to be inhibited from looking ahead carelessly when the setting of the wiper is changed and enables the driver to be inhibited from being unpleasant to the current setting value in the automatic mode.

For example, when the power window is intended as a vehicle-mounted device, the operation member of the vehicle-mounted device is a door switch for lifting and lowering window glass, the door switch being provided inside a door. The door switch is configured such that the window glass is lifted by being pulled up by the driver, and the window glass is lowered by being pushed downward by the driver. The door switch is configured to be capable of transmitting, to the control device 40, the result of detection of the external load when the external load due to the pulling-up operation of the driver is detected even with the window glass closed. The processor 41 of the control device 40 outputs, to the driver, a setting screen for changing the setting of the power window that corresponds to the vehicle-mounted device to which it is determined that the external load is applied as in the embodiment described above. The setting screen that is displayed on the display 21 of the input-output device 20 may include a virtual switch that can be operated by the driver and that is used, for example, to set whether a lock mechanism for the power window is released.

### Second Modification

According to a second modification, when the vehicle 1 includes a camera that images the vicinity of the driver and a vehicle-mounted device, the processor 41 of the control device 40 may perform processing described below instead of the various sensors described above. That is, the processor 41 may determine whether the external load is applied to the movable member or the operation member of the vehicle-mounted device by using a known image recognition technique or any image recognition technique on an image that is captured by the camera.

### Others

The techniques according to the present disclosure can be implemented as the vehicle 1 that includes the control device 40 according to the embodiment described above, a control method that is performed by the control device 40, a computer program that causes a computer to serve as the control device 40 described above, and a physical non-transitory recording medium that records the computer program.

The control device 40 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control device 40 including one or more processors and one or more memories. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A control device configured to control a vehicle-mounted device that is mounted in a vehicle, the control device comprising:
one or more processors; and
one or more memories that are coupled to the one or more processors such that the one or more memories are capable of communicating with the one or more processors,
wherein the one or more processors are configured to:
determine whether an external load is applied to a movable member or an operation member of the vehicle-mounted device; and
output, to a driver who drives the vehicle, a setting screen for changing a setting of the vehicle-mounted device to which the external load is applied when it is determined that the external load is applied.

2. The control device according to claim 1,
wherein the one or more processors are configured to determine that the external load is applied when magnitude of the external load is within a predetermined range for detecting contact of the driver with the movable member or an operation of the driver on the operation member.

3. The control device according to claim 2,
wherein the one or more processors are configured to:
acquire a target setting value of the vehicle-mounted device to which the external load is applied, based on an input operation of the driver into the setting screen; and
change the setting of the vehicle-mounted device, based on the acquired target setting value.

4. The control device according to claim 1,
wherein an input-output device that is mounted in the vehicle is configured to display images that are structured in advance into layers sequentially from an upper layer toward a lower layer in response to an input operation of the driver, and
wherein the one or more processors are configured to:
temporarily set, as an uppermost layer, a layer of the setting screen of the vehicle-mounted device to which the external load is applied; and
cause the input-output device to display the setting screen without the input operation.

5. The control device according to claim 1,
wherein the one or more processors are configured to display the setting screen of the vehicle-mounted device to which the external load is applied more preferentially or emphatically than another screen that is displayed on the input-output device when the setting screen is displayed on the input-output device that is mounted in the vehicle.
